(19) United States
(12) Patent Application Publication
(10) Pub. No.: US 2025/0125372 A1
(43) Pub. Date: Apr. 17, 2025

(54) ALL-SOLID-STATE BATTERY AND METHOD OF MANUFACTURING SAME

(71) Applicants: Hyundai Motor Company, Seoul (KR); Kia Corporation, Seoul (KR); Foundation of Soongsil University-Industry Cooperation, Seoul (KR)

(72) Inventors: Ji Young Kim, Suwon (KR); Sam Ick Son, Suwon (KR); Ki Yoon Bae, Seoul (KR); Young Jin Jeong, Seoul (KR); Jo Moon, Seoul (KR); Gyo Sik Kim, Ansan (KR); Hae Joo Kim, Yongin (KR)

(21) Appl. No.: 18/604,312

(22) Filed: Mar. 13, 2024

(30) Foreign Application Priority Data
Oct. 12, 2023 (KR) 10-2023-0135629

(51) Int. Cl. H01M 4/62; H01M 4/02; H01M 4/13; H01M 10/0562

(52) U.S. Cl. CPC H01M 4/628; H01M 4/13; H01M 10/0562; H01M 2004/021; H01M 2220/20; H01M 2300/008

(57) ABSTRACT

Disclosed are an all-solid-state battery and a method of manufacturing the same, in which the all-solid-state battery includes a coating layer configured such that the surface of a porous network formed by intertwining fibrous carbon is coated with an inorganic electrolyte, thus improving charge/discharge efficiency and lifespan characteristics thereof.

### CROSS-REFERENCE TO RELATED APPLICATION

This application claims, under 35 U.S.C. § 119 (a), the benefit of Korean Patent Application No. 10-2023-0135629, filed on Oct. 12, 2023, the entire contents of which are incorporated herein by reference.

### BACKGROUND

### (a) Technical Field

The present disclosure relates to an all-solid-state battery and a method of manufacturing the same, in which the all-solid-state battery includes a coating layer configured such that the surface of a porous network formed by intertwining fibrous carbon is coated with an inorganic electrolyte, thus improving charge/discharge efficiency and lifespan characteristics thereof.

### (b) Background

Secondary batteries capable of being charged and discharged are used not only for small electronic devices such as mobile phones, laptops, etc., but also for large transport vehicles such as hybrid vehicles, electric vehicles, etc. Accordingly, there is a need to develop secondary batteries having higher stability and energy density.

Most existing secondary batteries have cells based on organic solvents (organic liquid electrolytes), showing limitations in improving stability and energy density.

Meanwhile, all-solid-state batteries using inorganic solid electrolytes have recently been in the spotlight because it is possible to manufacture cells in a safer and simpler form based on technology that excludes organic solvents.

However, all-solid-state batteries have limitations in that energy density and output performance thereof do not reach those of lithium-ion batteries using conventional liquid electrolytes. With the goal of solving such problems, thorough research into improvement of the electrodes of all-solid-state batteries is ongoing.

In particular, graphite is mainly used as the anode of all-solid-state batteries. As such, a solid electrolyte with high specific gravity must be added in excess along with graphite to attain ionic conductivity, resulting in very low energy density per weight compared to lithium-ion batteries. Also, when using lithium metal as an anode, there are technical limitations in view of price competitiveness and large area formation.

Currently, many studies are conducted on all-solid-state batteries with high energy density, and in particular, an anodeless-type all-solid-state battery is receiving attention. An anodeless-type all-solid-state battery is a battery that precipitates lithium on the anode current collector, rather than using an anode active material such as graphite or lithium metal.

Anodeless-type all-solid-state batteries may theoretically achieve high energy density, but problems may arise such as possibility of short circuits due to uneven precipitation of lithium and deteriorated battery performance due to increased irreversible reaction.

### SUMMARY

In one aspect, an all-solid-state battery is provided in which a coating layer with superior ionic conductivity and electrical conductivity in a balanced manner is interposed between an anode current collector and a solid electrolyte layer, and a method of manufacturing the same.

The objects of the present disclosure are not limited to the foregoing. The objects of the present disclosure will be able to be clearly understood through the following description and to be realized by the means described in the claims and combinations thereof.

In one aspect, an all-solid-state battery is provided, comprising: a) an anode current collector; b) a coating layer disposed on the anode current collector; c) a solid electrolyte layer disposed on the coating layer; d) a cathode active material layer disposed on the solid electrolyte layer; and e) a cathode current collector disposed on the cathode active material layer, wherein the coating layer comprises a porous network comprising fibrous carbon.

In aspects, the porous network may be formed by or obtainable from intertwining fibrous carbon and an inorganic electrolyte. In aspects, the inorganic electrolyte suitably may coat at least a portion of a surface of the network. An aspect of the present disclosure provides an all-solid-state battery, including an anode current collector, a coating layer disposed on the anode current collector, a solid electrolyte layer disposed on the coating layer, a cathode active material layer disposed on the solid electrolyte layer, and a cathode current collector disposed on the cathode active material layer, in which the coating layer includes a porous network formed by intertwining fibrous carbon and an inorganic electrolyte which coats at least a portion of the surface of the network.

In an exemplary embodiment, the thickness of the coating layer may be 5 μm to 30 μm.

Preferably, the thickness of the coating layer may be greater than 5 μm and less than 20 μm.

In an exemplary embodiment, the fibrous carbon may include at least one selected from the group consisting of carbon nanofibers, carbon nanotubes, vapor grown carbon fibers, and combinations thereof.

In an exemplary embodiment, the coating layer may not include a conductive material or a binder.

In an exemplary embodiment, the inorganic electrolyte may be sulfur-based.

In an exemplary embodiment, the sulfur-based inorganic electrolyte may be lithium phosphorus sulfur chloride (LPSCl).

Another aspect of the present disclosure provides a method of manufacturing an all-solid-state battery, including preparing a porous network formed by intertwining fibrous carbon, obtaining an intermediate by immersing the porous network in a solution including an inorganic electrolyte, obtaining a coating layer by heat-treating the intermediate, obtaining an all-solid-state battery by stacking an anode current collector, the coating layer, a solid electrolyte layer, a cathode active material layer, and a cathode current collector, in which the coating layer includes the porous network and the inorganic electrolyte which coats at least a portion of the surface of the porous network.

In an exemplary embodiment, the porous network may be prepared by direct spinning.

In an exemplary embodiment, the fibrous carbon may include at least one selected from the group consisting of carbon nanofibers, carbon nanotubes, vapor grown carbon fibers, and combinations thereof.

In an exemplary embodiment, the solution may not include a binder or a conductive material.

In an exemplary embodiment, the solution may include about 0.3 wt % to about 5 wt % of the inorganic electrolyte.

In an exemplary embodiment, the solution may be obtained by dissolving the inorganic electrolyte in a solvent, and the solvent may comprise at least one selected from the group consisting of an alcoholic solvent, an organic solvent, a reaction solvent, and combinations thereof.

In an exemplary embodiment, the inorganic electrolyte may include sulfur-based inorganic electrolyte. The sulfur-based inorganic electrolyte may be lithium phosphorus sulfur chloride (LPSCl).

The alcoholic solvent may include ethanol, or other alkyl alcohol such as propanol, or other polar solvent.

The organic solvent may include one selected from the group consisting of acetonitrile, xylene and combinations thereof, or other suitably solvent such as toluene, methylene chloride and others.

The reaction solvent may include tetrahydrofuran or other suitably organic solvent.

In an exemplary embodiment, the porous network may be immersed in the solution for about 5 to about 30 minutes.

In an exemplary embodiment, the method may further include drying the intermediate at room temperature after obtaining the intermediate.

In an exemplary embodiment, heat-treating the intermediate may be performed at about 50° C. to about 450° C. Also, heat-treating the intermediate may be performed for about 6 to about 24 hours.

As discussed, in aspects, the present methods and systems suitably include use of a controller or processer.

A term “all-solid-state battery” as used herein includes or refers to a rechargeable battery (including a secondary battery) that includes an electrolyte in a solid state, e.g., gel or polymer (cured), which may include an ionomer and other electrolytic components for transferring ions between the electrodes of the battery. In an aspect, “all-solid-state battery” may include a secondary battery, including as used with a vehicle.

In a further aspect, a vehicle is provided comprising a battery as disclosed herein.

Other aspects of the invention are disclosed infra.

### BRIEF DESCRIPTION OF THE DRAWINGS

The above and other features of the present disclosure will now be described in detail referring to certain exemplary embodiments thereof illustrated in the accompanying drawings, which are given hereinbelow by way of illustration only, and thus are not limitative of the present disclosure, and wherein:

FIG. 1 schematically shows an all-solid-state battery according to the present disclosure;

FIG. 2 shows a scanning electron microscope (SEM) image of a coating layer according to Preparation Example 1;

FIG. 3 shows an SEM image of a porous network according to Comparative Preparation Example 1;

FIGS. 4 and 5 show results of BET specific surface area analysis for the coating layer according to Preparation Example 1, respectively;

FIGS. 6 and 7 show results of BET specific surface area analysis for the porous network according to Comparative Preparation Example 1, respectively;

FIGS. 8 and 9 show results of analysis of the coating layer according to Preparation Example 1 using mercury porosimetry, respectively;

FIGS. 10 and 11 show results of analysis of the porous network according to Comparative Preparation Example 1 using mercury porosimetry, respectively;

FIG. 12 shows results of analysis of cycle characteristics of all-solid-state batteries according to Comparative Examples 1 to 3;

FIG. 13 shows results of analysis of cycle characteristics of an all-solid-state battery according to Comparative Example 4;

FIG. 14 shows results of analysis of cycle characteristics of all-solid-state batteries according to Examples 1 to 3;

FIG. 15 shows results of analysis of cycle characteristics of the all-solid-state batteries according to Example 1 and Comparative Example 1;

FIG. 16 shows results of evaluation of room-temperature operation characteristics of the all-solid-state battery according to Comparative Example 1; and

FIG. 17 shows results of evaluation of room-temperature operation characteristics of an all-solid-state battery using a carbon nanotube sheet as an anode current collector.

### DETAILED DESCRIPTION

The above and other objects, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

### All-Solid-State Battery

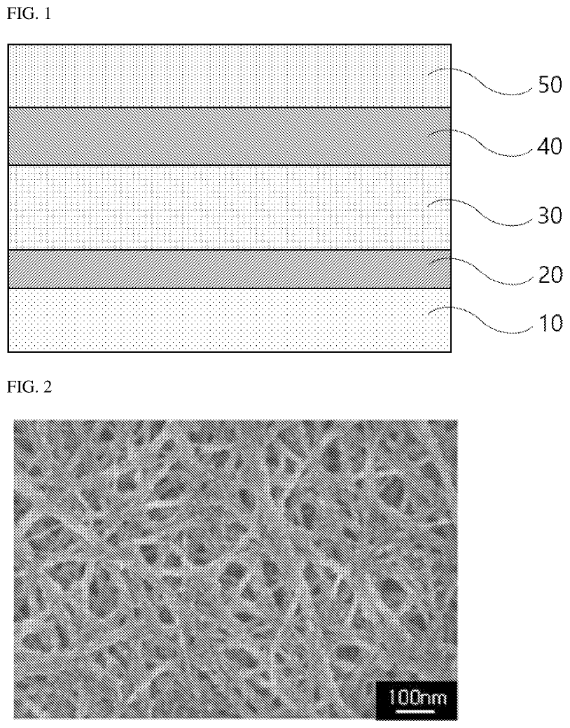

FIG. 1 schematically shows an all-solid-state battery according to the present disclosure. Referring to FIG. 1, an all-solid-state battery according to an aspect of the present disclosure may include an anode current collector 10, a coating layer 20 disposed on the anode current collector 10, a solid electrolyte layer 30 disposed on the coating layer 20, a cathode active material layer 40 disposed on the solid electrolyte layer 30, and a cathode current collector 50 disposed on the cathode active material layer 40, in which the coating layer 20 may include a porous network formed by intertwining fibrous carbon and an inorganic electrolyte which coats at least a portion of the surface of the network.

The anode current collector 10 may be a plate-type substrate having electrical conductivity. Specifically, the anode current collector 10 may be in the form of a sheet, a thin film, or a foil.

The anode current collector 10 may include a material that does not react with lithium. Specifically, the anode current collector 10 may include at least one selected from the group consisting of nickel (Ni), copper (Cu), stainless steel, and combinations thereof.

The thickness of the anode current collector 10 is not particularly limited, and may be, for example, 1 μm to 500 μm.

During charging of the all-solid-state battery, lithium ions released from the cathode active material layer 40 may move toward the coating layer 20 through the solid electrolyte layer 30. Lithium ions that reach the coating layer 20 may be stored in the form of a metal at the interface between the coating layer 20 and the solid electrolyte layer 30 or inside the coating layer 20 by reduction reaction with electrons emitted from the anode current collector 10.

As such, since the coating layer 20 includes both the inorganic electrolyte with high ionic conductivity and the fibrous carbon with high electrical conductivity, lithium may be uniformly precipitated on the coating layer 20. Accordingly, growth of lithium dendrites due to repeated charging and discharging of the all-solid-state battery may be suppressed and lifespan characteristics thereof may be improved.

In addition, according to the present disclosure, since an anode active material capable of alloying reaction with lithium is not included, charging and discharging of the all-solid-state battery may occur by oxidation/reduction reaction of lithium ions rather than alloying reaction of lithium, enabling operation thereof at relatively low temperatures. The all-solid-state battery according to the present disclosure may be an anodeless battery not including an anode active material.

Also, the coating layer 20 may include a network formed by intertwining fibrous carbon. The network may be porous, due to voids or pores, which are spaces in the fibrous carbon. The network may provide a space to store lithium that is precipitated in the form of metal by reduction of lithium ions when charging an all-solid-state battery.

In an exemplary embodiment, the fibrous carbon may include at least one selected from the group consisting of carbon nanofibers, carbon nanotubes, vapor grown carbon fibers, and combinations thereof.

In an exemplary embodiment, the thickness of the coating layer 20 may be 5 μm to 30 μm. Preferably, the thickness of the coating layer 20 may be greater than 5 μm and less than 20 μm. If the thickness of the coating layer 20 is 5 μm or less, capacity of the battery may decrease due to insufficient space for lithium ions to be reduced in metal form when charging the all-solid-state battery. On the other hand, if the thickness of the coating layer 20 is 20 μm or more, the energy density may decrease, and some of lithium precipitated inside the coating layer 20 during charging may be irreversibly stored, deteriorating cycle characteristics.

Meanwhile, the average diameter D₅₀ of fibrous carbon that is not coated with the inorganic electrolyte may be 20 nm or more, and for example, 20 nm to 30 nm. In an exemplary embodiment, the average diameter D₅₀ of fibrous carbon coated with the inorganic electrolyte according to the present disclosure may be 25 nm or more. Here, the average diameter of fibrous carbon may indicate an average diameter of a bundle in which a plurality of fibers is gathered. If the average diameter of fibrous carbon is less than 25 nm, it may mean that the surface of the porous network formed by intertwining fibrous carbon is not properly coated with the inorganic electrolyte.

The upper limit of the average diameter of fibrous carbon is not particularly limited, and may be, for example, 25 nm to 1,000 nm, or 35 nm to 100 nm. The average diameter of fibrous carbon coated with the inorganic electrolyte may vary depending on the average diameter D₅₀ of fibrous carbon not coated with the inorganic electrolyte and the coating thickness of the inorganic electrolyte.

In an exemplary embodiment, the coating layer 20 may not include a conductive material or a binder. The coating layer 20 according to the present disclosure includes the porous network formed by intertwining fibrous carbon with high electrical conductivity, and thus may not include an additional conductive material to increase electrical conductivity. Also, the coating layer 20 includes the inorganic electrolyte which coats at least a portion of the surface of the network, thereby increasing roughness of the surface of the network, and thus may not include an additional binder.

Meanwhile, the inorganic electrolyte may be a solid electrolyte with lithium ion conductivity. The inorganic electrolyte may include an oxide-based inorganic electrolyte, a sulfide-based inorganic electrolyte, etc. Preferably a sulfide-based inorganic electrolyte with high lithium ion conductivity may be used. The sulfide-based inorganic electrolyte is not particularly limited, but examples thereof may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (in which m and n are positive numbers, and Z is any one selected from among Ge, Zn, and Ga), Li₂S—GeS₂, Li₂S—SiS₂—Li₃PO₄, Li₂S—SiS₂—LiₓMO_{y} (in which x and y are positive numbers, and M is any one selected from among P, Si, Ge, B, Al, Ga, and In), Li₁₀GeP₂S₁₂, and the like.

Examples of the oxide-based inorganic electrolyte may include perovskite-type LLTO (Li₃ₓLa_{2/3-x}TiO₃), phosphate-based NASICON-type LATP (Li₁₊ₓAlₓTi₂₋ₓ (PO₄)₃), and the like.

The solid electrolyte layer 30 may be disposed between the cathode active material layer 40 and the coating layer 20 and may include a solid electrolyte having lithium ion conductivity.

The solid electrolyte may include at least one selected from the group consisting of an oxide-based solid electrolyte, a sulfide-based solid electrolyte, a polymer electrolyte, and combinations thereof. Preferably, a sulfide-based solid electrolyte having high lithium ion conductivity may be used.

The sulfide-based solid electrolyte is not particularly limited, but examples thereof may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (in which m and n are positive numbers, and Z is any one selected from among Ge, Zn, and Ga), Li₂S—GeS₂, Li₂S—SiS₂—Li₃PO₄, Li₂S—SiS₂-LiₓMO_{y} (in which x and y are positive numbers, and M is any one selected from among P, Si, Ge, B, Al, Ga, and In), Li₁₀GeP₂S₁₂, and the like.

Examples of the oxide-based solid electrolyte may include perovskite-type LLTO (Li₃ₓLa_{2/3-x}TiO₃), phosphate-based NASICON-type LATP (Li₁₊ₓAlₓTi₂₋ₓ (PO₄) 3), and the like.

Examples of the polymer electrolyte may include a gel polymer electrolyte, a solid polymer electrolyte, and the like.

The solid electrolyte layer 30 may further include a binder. Examples of the binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), and the like.

Here, the solid electrolyte included in the solid electrolyte layer 30 and the inorganic electrolyte included in the coating layer 20 may be the same as or different from each other.

The cathode active material layer 40 is capable of reversibly intercalating and deintercalating lithium ions, and may include a cathode active material, a conductive material, a binder, etc. Also, some of the solid electrolyte may be mixed.

The cathode active material may be an oxide active material or a sulfide active material. Examples of the oxide active material may include a rock-salt-layer-type active material such as LiCoO₂, LiMnO₂, LiNiO₂, LiVO₂, Li₁₊ₓNi_{1/3}Co_{1/3}Mn_{1/3}O₂, etc., a spinel-type active material such as LiMn₂O₄, Li(Ni_{0.5}Mn_{1.5})O₄, etc., an inverse-spinel-type active material such as LiNiVO₄, LiCoVO₄, etc., an olivine-type active material such as LiFePO₄, LiMnPO₄, LiCoPO₄, LiNiPO₄, etc., a silicon-including active material such as Li₂FeSiO₄, Li₂MnSiO₄, etc., a rock-salt-layer-type active material in which a portion of a transition metal is substituted with a different metal, such as LiNi_{0.8}Co_{(0.2-x)}AlₓO₂ (0<x<0.2), a spinel-type active material in which a portion of a transition metal is substituted with a different metal, such as Li₁₊ₓMn_{2-x-y}MyO₄ (in which M is at least one selected from among Al, Mg, Co, Fe, Ni, and Zn, 0<x+y<2), lithium titanate such as Li₄Ti₅O₁₂, and the like.

Examples of the sulfide active material may include copper Chevrel, iron sulfide, cobalt sulfide, nickel sulfide, and the like.

The solid electrolyte mixed in the cathode active material layer 40 may be substantially the same as the solid electrolyte included in the solid electrolyte layer 30.

Examples of the conductive material may include carbon black, conductive graphite, ethylene black, carbon fiber, graphene, and the like.

Examples of the binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), and the like.

The cathode current collector 50 may include a plate-type substrate having electrical conductivity. Specifically, the cathode current collector 50 may be in the form of a sheet or a thin film. The cathode current collector 50 may include at least one selected from the group consisting of indium (In), copper (Cu), magnesium (Mg), aluminum (Al), stainless steel, iron, and combinations thereof. Specifically, the cathode current collector 50 may include an aluminum foil.

The thickness of the cathode current collector 50 is not particularly limited, and may be, for example, 1 μm to 500 μm.

Method of Manufacturing all-Solid-State Battery

Another aspect of the present disclosure pertains to a method of manufacturing an all-solid-state battery, including preparing a porous network formed by intertwining fibrous carbon, obtaining an intermediate by immersing the network in a solution including an inorganic electrolyte, obtaining a coating layer 20 by heat-treating the intermediate, and obtaining an all-solid-state battery by stacking an anode current collector 10, the coating layer 20, a solid electrolyte layer 30, a cathode active material layer 40, and a cathode current collector 50, in which the coating layer 20 may include the network and the inorganic electrolyte which coats at least a portion of the surface of the network.

The porous network formed by intertwining fibrous carbon may be prepared by a method generally used to synthesize a sheet-type carbon material. For example, chemical vapor deposition, particularly direct spinning, may be used.

The Direct spinning is a kind of process of forming carbon nanotubes into fibers, which allows synthesis of carbon nanotube fibers and is mainly used to synthesize fibrous carbon.

The Direct spinning may be performed in a manner in which a precursor solution, including a material for fibrous carbon, a catalyst, and a promoter, and carrier gas are injected at a predetermined rate into an electric furnace of a vertical CVD (chemical vapor deposition) device to synthesize a carbon nanotube aerogel, which is then processed in fiber form using a winding roller, yielding fibrous carbon. Here, the fibrous carbon may be obtained in the form of a sheet.

In obtaining the fibrous carbon through direct spinning, fibrous carbon with any shape, thickness, and porosity may be synthesized by controlling the material for fibrous carbon, the temperature of the electric furnace, the winding speed of the winding roller, etc.

The material for fibrous carbon may include at least one selected from the group consisting of a C₂-C₁₀ saturated or unsaturated hydrocarbon, alcohol, and ketone. The catalyst may include at least one selected from the group consisting of ferrocene, copper (Cu), chromium (Cr), molybdenum (Mo), tungsten (W), iron (Fe), cobalt (Co), nickel (Ni), ruthenium (Ru), rhodium (Rh), palladium (Pd), osmium (Os), iridium (Ir), and platinum (Pt), and particularly may include ferrocene. The promoter may be either thiophene or carbon disulfide. The carrier gas is not particularly limited so long as it is used to synthesize fibrous carbon using CVD or direct spinning, and for example, hydrogen (H₂) may be used.

Also, when the winding speed of the winding roller is increased in obtaining the fibrous carbon through direct spinning, porosity of the fibrous carbon may increase. Moreover, the porous network may be purchased and used on the market rather than synthesized directly.

The porous network thus prepared may be immersed in a solution including an inorganic electrolyte, thus obtaining an intermediate.

Here, the solution is obtained by dissolving the inorganic electrolyte in a solvent, and the solvent may include at least one selected from the group consisting of an alcoholic solvent, an organic solvent, a reaction solvent, and combinations thereof.

The type of alcoholic solvent is not particularly limited, and for example, ethanol, etc. may be used. The type of organic solvent is not particularly limited, and for example, acetonitrile, xylene, etc. may be used. The type of reaction solvent is not particularly limited, and for example, tetrahydrofuran, etc. may be used.

Meanwhile, in preparing the solution, the solution may not include a binder or a conductive material.

In an exemplary embodiment, the solution may include 0.3 wt % to 5 wt % of the inorganic electrolyte. If the amount of the inorganic electrolyte based on the total weight of the solution is less than 0.3 wt %, ionic conductivity of the manufactured coating layer 20 may be low. On the other hand, if the amount of the inorganic electrolyte exceeds 5 wt %, the surface of the network may be excessively coated with the inorganic electrolyte, resulting in very low porosity of the coating layer 20 and decreased energy density and battery capacity. Preferably, the solution may include 1.0 wt % to 1.5 wt % of the inorganic electrolyte. When the concentration of the inorganic electrolyte falls within the above range, further improved battery lifespan characteristics may be attained.

In immersing the network in the solution, the inorganic electrolyte included in the solution may be uniformly distributed inside the pores of the network and on the surface of the fibrous carbon.

In an exemplary embodiment, the network may be immersed in the solution for 5 to 30 minutes. If the immersion time of the network is less than 5 minutes, the inorganic electrolyte in the solution cannot be sufficiently introduced into the pores of the network and onto the surface of the fibrous carbon. On the other hand, if the immersion time of the network exceeds 30 minutes, the inorganic electrolyte may be excessively distributed inside the pores of the network and on the surface of the fibrous carbon, so that the porosity of the coating layer 20 may be excessively lowered and the energy density and battery capacity may be decreased.

Thereafter, by removing the solvent through heat treatment of the intermediate, the coating layer 20 including the network and the inorganic electrolyte with which at least a portion of the surface of the network is coated may be obtained.

In an exemplary embodiment, the heat treatment may be performed at 50° C. to 450° C. If the heat treatment temperature is lower than 50° C., crystallinity of the inorganic electrolyte may decrease and ionic conductivity may decrease. On the other hand, if the heat treatment temperature exceeds 450° C., the inorganic electrolyte in addition to the solvent may be removed, lowering ionic conductivity of the battery.

Also, the heat treatment may be performed for 6 to 24 hours. If the heat treatment time is less than 6 hours, the solvent distributed inside the pores of the network and on the surface of the fibrous carbon cannot be completely removed. On the other hand, if the heat treatment time exceeds 24 hours, the inorganic electrolyte in addition to the solvent may be removed, lowering ionic conductivity of the battery.

Meanwhile, in an exemplary embodiment, drying at room temperature may be further performed after obtaining the intermediate. When the intermediate is dried at room temperature, the highly volatile solvent may be primarily removed.

After obtaining the coating layer 20 by heat-treating the intermediate, an all-solid-state battery may be obtained by stacking an anode current collector 10, the coating layer 20, a solid electrolyte layer 30, a cathode active material layer 40, and a cathode current collector 50. A method of obtaining an all-solid-state battery by stacking the anode current collector 10, the coating layer 20, the solid electrolyte layer 30, the cathode active material layer 40, and the cathode current collector 50 may be performed through a typical method used in the art.

Moreover, since individual components of the all-solid-state battery manufactured by the manufacturing method described above are substantially the same as those described above, a detailed description thereof will be omitted.

A better understanding of the present disclosure may be obtained through the following examples. However, these examples are merely set forth to illustrate the present disclosure, and are not construed as limiting the scope of the present disclosure.

### Preparation Example 1

(1) A precursor solution was prepared by mixing ethylene glycol with acetone as a material for fibrous carbon, ferrocene as a transition metal source for catalysis, and thiophene as a promoter.

The precursor solution and carrier gas (H₂, 2,200 sccm) were injected at a predetermined rate into an electric furnace of a vertical CVD device to synthesize a carbon nanotube sheet as a porous network formed by intertwining fibrous carbon by direct spinning. Here, the winding speed of the roller was appropriately adjusted so that the thickness of the carbon nanotube sheet was 10 μm.

(2) A solution was prepared by dissolving LPSCl as a sulfide-based inorganic electrolyte in a mixed solvent of ethanol, acetonitrile, and tetrahydrofuran. Here, the concentration of the inorganic electrolyte was set to 1.25 wt % based on the total mass of the solution.

(3) The carbon nanotube sheet was immersed in the solution for 30 minutes to obtain an intermediate, which was then taken out and dried at room temperature for 2 hours.

(4) Thereafter, the intermediate was heat-treated at 100° C. for 6 hours in a vacuum atmosphere, thereby obtaining a coating layer including the carbon nanotube sheet and the inorganic electrolyte with which at least a portion of the surface of the carbon nanotube sheet was coated.

### Preparation Example 2

A coating layer was prepared in the same manner as in Preparation Example 1, with the exception that, during preparation of the solution, the concentration of the inorganic electrolyte was set to 0.63 wt % based on the total mass of the solution.

### Preparation Example 3

A coating layer was prepared in the same manner as in Preparation Example 1, with the exception that, during preparation of the solution, the concentration of the inorganic electrolyte was set to 0.32 wt % based on the total mass of the solution.

### Comparative Preparation Example 1

A precursor solution was prepared by mixing ethylene glycol with acetone as a material for fibrous carbon, ferrocene as a transition metal source for catalysis, and thiophene as a promoter.

The precursor solution and carrier gas (H₂, 2,200 sccm) were injected at a predetermined rate into an electric furnace of a vertical CVD device to synthesize a carbon nanotube sheet as a porous network formed by intertwining fibrous carbon by direct spinning. Here, the winding speed of the roller was appropriately adjusted so that the thickness of the carbon nanotube sheet was 10 μm.

### Comparative Preparation Example 2

A carbon nanotube sheet was manufactured in the same manner as in Comparative Preparation Example 1, with the exception that the winding speed of the roller was appropriately adjusted so that the thickness of the carbon nanotube sheet was 20 μm.

### Comparative Preparation Example 3

A carbon nanotube sheet was manufactured in the same manner as in Comparative Preparation Example 1, with the exception that the winding speed of the roller was appropriately adjusted so that the thickness of the carbon nanotube sheet was 30 μm.

### Comparative Preparation Example 4

A carbon nanotube sheet was manufactured in the same manner as in Comparative Preparation Example 1, with the exception that the winding speed of the roller was appropriately adjusted so that the thickness of the carbon nanotube sheet was 5 μm.

### Test Example 1—SEM Imaging Results

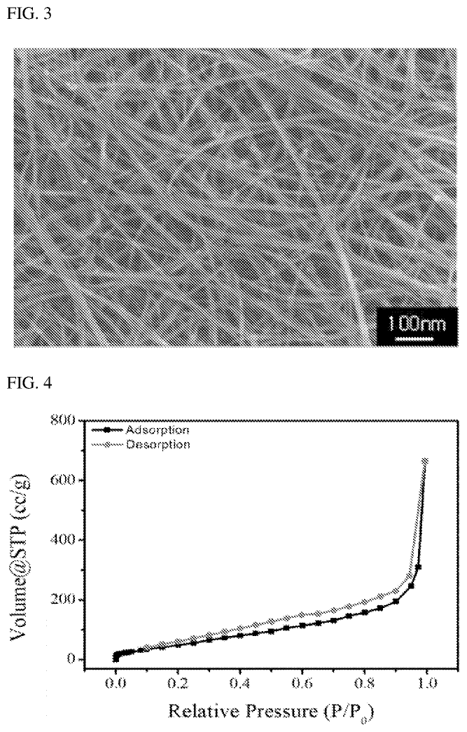

In order to determine whether the coating layer synthesized according to the manufacturing method of the present disclosure was configured such that the surface of the carbon nanotube sheet was properly coated with the inorganic electrolyte, the SEM imaging results of Preparation Example 1 and Comparative Preparation Example 1 are shown in FIGS. 2 and 3, respectively.

Referring to FIGS. 2 and 3, the size of the carbon nanotube bundle was increased from about 21.46 nm to 59.16 nm, and also, surface roughness of the carbon nanotube bundle was increased, confirming that the coating layer was configured such that the surface of the network was properly coated with the inorganic electrolyte.

### Test Example 2—Analysis of Specific Surface Area and Porosity Using BET Method

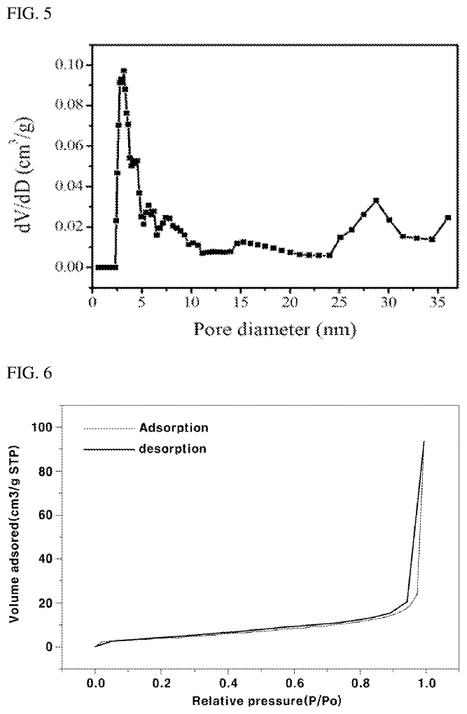

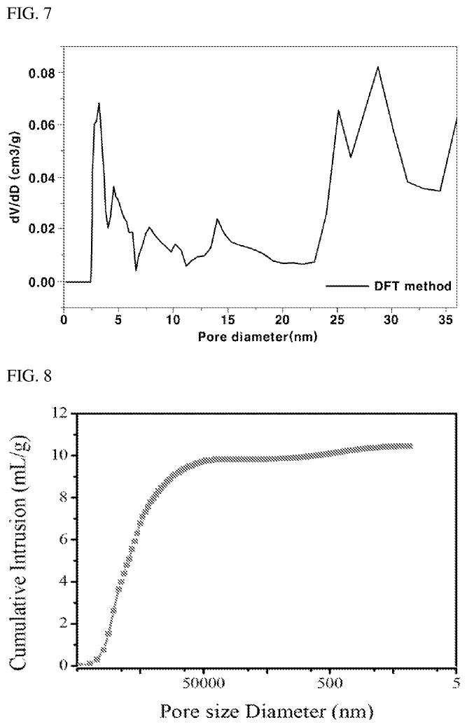

FIGS. 4 and 5 show results of microscale (carbon nanotube bundle) BET specific surface area analysis for the coating layer according to Preparation Example 1. FIGS. 6 and 7 show results of microscale (carbon nanotube bundle) BET specific surface area analysis for the porous network according to Comparative Preparation Example 1, respectively. Also, specific numerical values for the analysis results are shown in Table 1 below.

For BET specific surface area analysis for Preparation Example 1 and Comparative Preparation Example 1, a known specific surface area measuring instrument (TESKO) was used.

TABLE 1

| | Preparation | Comparative |
|---|---|---|
| | Example 1 | Preparation Example 1 |
| Specific surface area (m²/g) | 203.60 | 224.58 |
| Porosity (%) | 50.29 | 60 |

Referring to FIGS. 4 to 7 and Table 1, the specific surface area and porosity of Preparation Example 1, in which the surface of the carbon nanotube bundle was coated with the inorganic electrolyte, were measured to be lower than those in Comparative Preparation Example 1 without coating.

This is deemed to be because the space in fibrous carbon was decreased due to coating with the inorganic electrolyte. When the porosity of the coating layer is decreased in this way, the amount of lithium precipitated inside the coating layer may be decreased during charging of an all-solid-state battery, and the amount thereof precipitated at the interface between the coating layer and the solid electrolyte layer may be increased. Briefly, the coating layer is capable of functioning as an anode current collector.

### Test Example 3—Total Pore Area and Porosity Using Mercury Porosimetry

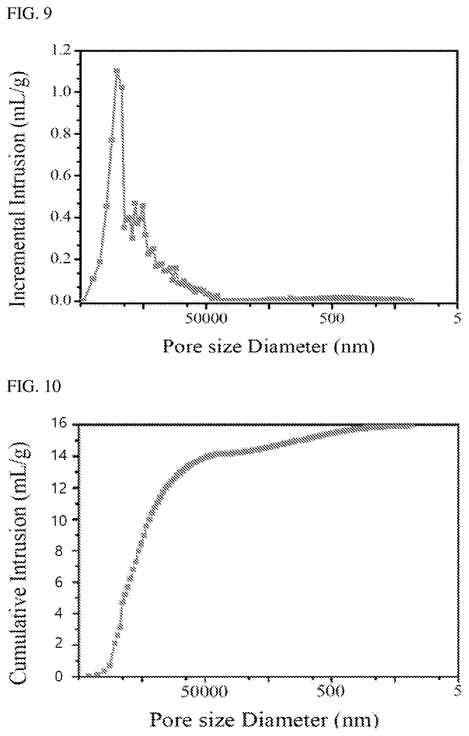

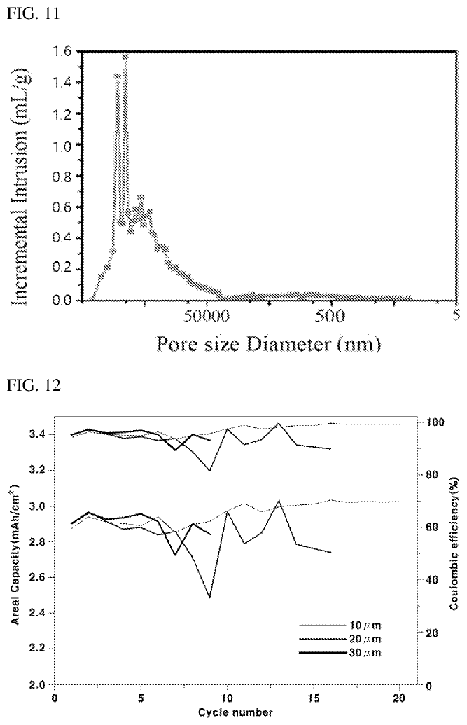

FIGS. 8 and 9 show results of analysis of the total pore area and porosity of the coating layer according to Preparation Example 1 using mercury porosimetry. FIGS. 10 and 11 show results of analysis of the total pore area and porosity of the porous network according to Comparative Preparation Example 1 using mercury porosimetry, respectively. Also, specific numerical values for the analysis results are shown in Table 2 below.

As such, analysis was performed on a macroscale (carbon nanotube sheet) and a known mercury porosimeter (AutoPore V, Micromeritics) was used.

TABLE 2

| | Preparation | Comparative |
|---|---|---|
| | Example 1 | Preparation Example 1 |
| Total pore area (m²/g) | 59.35 | 94.79 |
| Porosity (%) | 95.4 | 96.9 |

Referring to FIGS. 8 to 11 and Table 2, the total pore area and porosity of Preparation Example 1, in which the surface of the carbon nanotube bundle was coated with the inorganic electrolyte, were measured to be lower than those in Comparative Preparation Example 1 without coating.

This is deemed to be because the total pore area and porosity of the overall carbon nanotube sheet were decreased due to uniform coating of the surface of the carbon nanotube bundle with the inorganic electrolyte.

### Example 1

The coating layer according to Preparation Example 1 and a solid electrolyte layer including a sulfide-based solid electrolyte were stacked on a nickel (Ni) thin film as an anode current collector. The sulfide-based solid electrolyte used was Li₆PS₅Cl. A half-cell was manufactured by attaching lithium metal to the upper side of the solid electrolyte layer, followed by pressing.

### Example 2

A half-cell was manufactured in the same manner as in Example 1, with the exception that the coating layer according to Preparation Example 2 was used.

### Example 3

A half-cell was manufactured in the same manner as in Example 1, with the exception that the coating layer according to Preparation Example 3 was used.

### Comparative Example 1

A half-cell was manufactured in the same manner as in Example 1, with the exception that the carbon nanotube sheet according to Comparative Preparation Example 1 was used.

### Comparative Example 2

A half-cell was manufactured in the same manner as in Example 1, with the exception that the carbon nanotube sheet according to Comparative Preparation Example 2 was used.

### Comparative Example 3

A half-cell was manufactured in the same manner as in Example 1, with the exception that the carbon nanotube sheet according to Comparative Preparation Example 3 was used.

### Comparative Example 4

A half-cell was manufactured in the same manner as in Example 1, with the exception that the carbon nanotube sheet according to Comparative Preparation Example 4 was used.

### Test Example 4—Analysis of Cycle Characteristics by Thickness of Carbon Nanotube Sheet

In order to evaluate the effect of the thickness of the carbon nanotube sheet used for the coating layer on the lifespan characteristics of the all-solid-state battery, areal capacity and Coulombic efficiency of the half-cells were measured by repeating charge and discharge cycles for Comparative Examples 1 to 3. Charging and discharging were performed under the following conditions: temperature: 50° C., current density: 1 mA·cm², capacity condition: 3.5 mAh·cm².

The results thereof are shown in FIG. 12, in which Coulombic efficiency is depicted in the top of the graph in FIG. 12 and areal capacity is depicted in the bottom thereof.

Referring to FIG. 12, the lifespan characteristics were the best when the thickness of the carbon nanotube sheet was 10 μm, and the lifespan characteristics deteriorated rapidly with an increase in the thickness of the sheet. This is deemed to be because, due to the properties of the carbon nanotube sheet with low lithium ion conductivity, lithium intercalated later is deintercalated first during charging and discharging, resulting in lithium being irreversibly trapped inside the sheet.

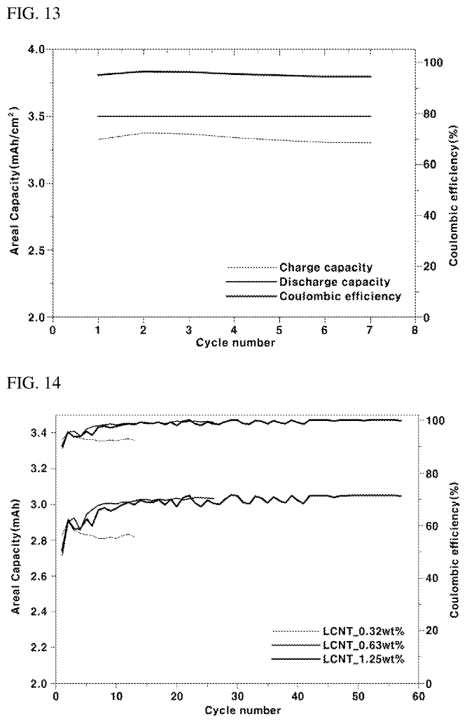

In addition, areal capacity and Coulombic efficiency of the half-cell were measured by repeating charge and discharge cycles for Comparative Example 4 under the same conditions as above. The results thereof are shown in FIG. 13, in which Coulombic efficiency is depicted in the top of the graph in FIG. 13 and charge and discharge capacities are depicted in the bottom thereof.

Referring to FIG. 13, stable charge/discharge behavior was shown until the beginning of charging and discharging (7th cycle), but from the 8th cycle, an internal short circuit occurred and testing could not proceed. This is deemed to be caused by an internal short circuit due to a lack of space for lithium intercalation and deintercalation by the use of the carbon nanotube sheet that is thin relative to the capacity.

Summarizing Test Example 4, it was confirmed that the areal capacity and Coulombic efficiency of the battery were the best when the carbon nanotube sheet not coated with the inorganic electrolyte had a thickness of about 10 μm. Since these results are due to the thickness of the carbon nanotube sheet, the same tendency is expected to appear even upon coating with an inorganic electrolyte.

### Test Example 5—Analysis of Cycle Characteristics by Concentration of Inorganic Electrolyte

In order to evaluate the effect of the concentration of the inorganic electrolyte included in the solution, cycle characteristics of the all-solid-state batteries according to Examples 1 to 3 were analyzed. The results thereof are shown in FIG. 14 and Table 3 below in which Coulombic efficiency is depicted in the top of the graph in FIG. 14 and arial capacities are depicted in the bottom thereof.

Charging and discharging were performed under the following conditions: temperature: 50° C., current density: 1 mA·cm², capacity condition: 3.5 mAh·cm².

TABLE 3

| Classification | Example 1 | Example 2 | Example 3 |
|---|---|---|---|
| Initial Coulombic efficiency | 90.0 | 89.1 | 92.7 |
| Cycle number | 58 | 26 | 13 |

Referring to FIG. 14 and Table 3, when the amount (concentration) of the inorganic electrolyte included in the solution was 1.25 wt %, the best lifespan characteristics were exhibited.

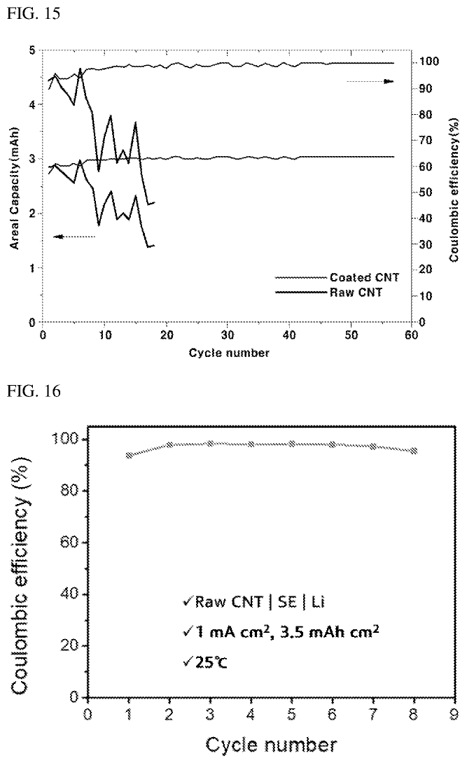

Also, FIG. 15 shows a comparison of the cycle characteristics of the all-solid-state batteries according to Example 1 and Comparative Example 1 in which Coulombic efficiency is depicted in the top of the graph in FIG. 15 and arial capacities are depicted in the bottom thereof. Charging and discharging were performed under the following conditions: temperature: 50° C., current density: 1 mA·cm², capacity condition: 3.5 mAh·cm².

Referring to FIG. 15, the initial capacity and Coulombic efficiency values of Example 1 and Comparative Example 1 were similar to each other, but the capacity and Coulombic efficiency of Comparative Example 1 decreased rapidly with an increase in the number of charge and discharge cycles. Moreover, it was confirmed that the lifespan characteristics of Example 1 were greatly increased compared to Comparative Example 1.

### Test Example 6—Analysis of Room-Temperature Operation Characteristics

In order to predict the possibility of room-temperature operation of the all-solid-state battery including the coating layer according to the present disclosure, cycle characteristics of the all-solid-state battery according to Comparative Example 1 at room temperature were analyzed. The results thereof are shown in FIG. 16. Charging and discharging were performed under the following conditions: temperature: 25° C., current density: 1 mA·cm², capacity condition: 3.5 mAh·cm².

Referring to FIG. 16, Comparative Example 1, including only the porous network not coated with the inorganic electrolyte, also showed good cycle characteristics upon operation at room temperature. Therefore, the all-solid-state battery according to the present disclosure, including the coating layer configured such that the surface of the porous network is coated with the inorganic electrolyte, is expected to have better room-temperature operation characteristics.

### Test Example 7—Possibility of Replacing Anode Current Collector

In order to predict whether the coating layer according to the present disclosure is able to replace an anode current collector, a solid electrolyte layer including a sulfide-based solid electrolyte was stacked directly on the carbon nanotube sheet according to Comparative Preparation Example 1. The sulfide-based solid electrolyte used was Li₆PS₅Cl. A half-cell was manufactured by attaching lithium metal to the upper side of the solid electrolyte layer, followed by pressing.

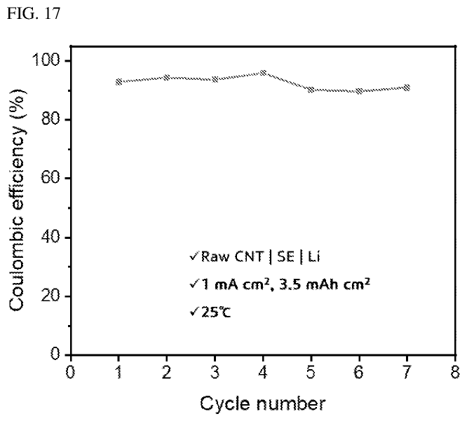

The cycle characteristics at room temperature were analyzed for the half-cell not using an anode current collector. The results thereof are shown in FIG. 17. Charging and discharging were performed under the following conditions: temperature: 25° C., current density: 1 mA·cm², capacity condition: 3.5 mAh·cm².

Referring to FIG. 17, good cycle characteristics were observed at room temperature despite not using a separate anode current collector. In relation thereto, a typical anode current collector serves to transfer electrons from the outside to the anode active material or to emit the same from the anode active material so that electrochemical reaction is able to occur during charging and discharging of the battery. Accordingly, high electrical conductivity is required.

Since the carbon nanotube sheet is known to have high electrical conductivity, good cycle characteristics are predicted to appear even when the carbon nanotube sheet is used instead of a typical anode current collector such as a Ni thin film.

Therefore, when the coating layer, configured such that the surface of the porous network with improved electrical conductivity and ionic conductivity in a balanced manner is coated with the inorganic electrolyte, is used as an anode current collector, even better cycle characteristics can be expected to appear than when using the carbon nanotube sheet as an anode current collector.

As is apparent from the above description, according to the present disclosure, lithium is stably precipitated on a coating layer with high electrical conductivity and ionic conductivity, thus suppressing formation of lithium dendrites and/or dead lithium, thereby increasing the lifespan of an all-solid-state battery.

According to the present disclosure, since an anode active material capable of alloying reaction with lithium is not used, charging and discharging of the all-solid-state battery can occur by oxidation/reduction reaction of lithium ions rather than alloying reaction of lithium, enabling operation thereof at relatively low temperatures.

The effects of the present disclosure are not limited to the above-mentioned effects. It should be understood that the effects of the present disclosure include all effects that can be inferred from the description of the present disclosure.

What is claimed is:

1. An all-solid-state battery, comprising:
an anode current collector;
a coating layer disposed on the anode current collector;
a solid electrolyte layer disposed on the coating layer;
a cathode active material layer disposed on the solid electrolyte layer; and
a cathode current collector disposed on the cathode active material layer,
wherein the coating layer comprises a porous network comprising fibrous carbon and an inorganic electrolyte.

2. The all-solid-state battery of claim 1, wherein a thickness of the coating layer is about 5 μm to about 30 μm.

3. The all-solid-state battery of claim 1, wherein the fibrous carbon comprises at least one selected from the group consisting of carbon nanofibers, carbon nanotubes, vapor grown carbon fibers, and combinations thereof.

4. The all-solid-state battery of claim 1, wherein the coating layer does not comprise a conductive material or a binder.

5. The all-solid-state battery of claim 1, wherein the inorganic electrolyte is sulfur-based.

6. The all-solid-state battery of claim 5, wherein the sulfur-based inorganic electrolyte is lithium phosphorus sulfur chloride (LPSCl).

7. A method of manufacturing an all-solid-state battery, the method comprising:
preparing a porous network formed by intertwining fibrous carbon;
obtaining an intermediate by immersing the porous network in a solution comprising an inorganic electrolyte;
obtaining a coating layer by heat-treating the intermediate;
obtaining an all-solid-state battery by stacking an anode current collector, the coating layer, a solid electrolyte layer, a cathode active material layer, and a cathode current collector,
wherein the coating layer comprises the porous network and the inorganic electrolyte which coats at least a portion of a surface of the porous network.

8. The method of claim 7, wherein the porous network is prepared by direct spinning.

9. The method of claim 7, wherein the fibrous carbon comprises at least one selected from the group consisting of carbon nanofibers, carbon nanotubes, vapor grown carbon fibers, and combinations thereof.

10. The method of claim 7, wherein the solution does not comprise a binder or a conductive material.

11. The method of claim 7, wherein the solution comprises 0.3 wt % to 5 wt % of the inorganic electrolyte.

12. The method of claim 7, wherein the solution is obtained by dissolving the inorganic electrolyte in a solvent, and the solvent may comprise at least one selected from the group consisting of an alcoholic solvent, an organic solvent, a reaction solvent, and combinations thereof.

13. The method of claim 7, wherein the inorganic electrolyte comprises sulfur-based inorganic electrolyte.

14. The method of claim 13, wherein the sulfur-based inorganic electrolyte is lithium phosphorus sulfur chloride (LPSCl).

15. The method of claim 12, wherein the alcoholic solvent comprises ethanol, and the organic solvent comprises one selected from the group consisting of acetonitrile, xylene and combinations thereof.

16. The method of claim 12, wherein the reaction solvent comprises tetrahydrofuran.

17. The method of claim 7, wherein the porous network is immersed in the solution for about 5 to about 30 minutes.

18. The method of claim 7, further comprising drying the intermediate at room temperature after obtaining the intermediate.

19. The method of claim 7, wherein heat-treating the intermediate is performed at about 50° C. to about 450° C. and for about 6 to 24 hours

20. A vehicle comprising the all-solid-state battery of claim 1.
